(19) United States
(12) Patent Application Publication
(10) Pub. No.: US 2011/0053741 A1
(43) Pub. Date: Mar. 3, 2011

(54) CORONA ROLLER AND METHODS FOR PRODUCING A CORONA ROLLER

(76) Inventors: Claus Heuser, Alzenau (DE); Markus Kirst, Buttleborn (DE); Gerhard Johner, Gelnhausen (DE); Christian Dudazy, Bruchkobel (DE)

(21) Appl. No.: 12/934,520

(22) PCT Filed: Mar. 24, 2009
(86) PCT No.: PCT/EP09/53448

§ 371 Date: Oct. 28, 2010

(30) Foreign Application Priority Data
Apr. 2, 2008 (DE) 102008016851.3

(51) Int. Cl. F16C 13/00; B05D 5/12; C23C 4/00

(52) U.S. Cl. 492/53; 427/58; 427/446

(57) ABSTRACT

Corona roller comprising a cylindrical base body and a roller cover of dielectric material, and method for producing it. The roller cover includes a layer of thermoplastic material, e.g. polyamide, applied onto the outer surface of the base body. Solid (powder) particles having electrically insulating characteristics are imbedded in the material matrix of said layer in the vicinity of the surface thereof in a form-locking manner such that merely a partial region of said particles protrudes from said inner layer. A hard, wear- and corrosion-resistant surface is formed at the outer side of the layer of plastic material, said hard, wear- and corrosion-resistant surface likewise having electrically insulating characteristics. For producing the corona roller, the layer of thermoplastic material is heated to a viscosity similar to that of honey. Preferably, a layer of oxide ceramic then is applied by thermal spraying, wherein the first powder particles thereof are shot into the heated layer of plastic material and subsequent particles form an outer functional layer. Alternatively, insulating particles of solid material may be dispersed into the heated layer of plastic material and may be ground thereby forming the wear-resistant surface.

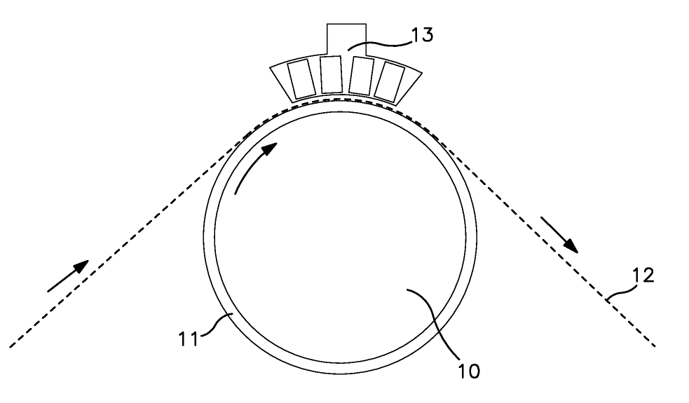

### BACKGROUND OF THE INVENTION

1. Field of the Invention

The invention relates to methods for producing a corona roller. The invention further relates to a corona roller comprising a cylindrical base body and a roller cover of dielectric material.

2. Description of Related Art

Frequently, aluminum oxide is used as dielectric material for the roller cover of a corona roller, wherein the aluminum oxide is applied on the roller body by plasma spraying. Such rollers are used in corona systems (reference is made to the attached drawing) in which e.g. foils of plastic material are pretreated with specific electrical discharges such that oxidation processes cause the surfaces thereof to become hydrophilic and thereby can be used in printing with conventional offset processes. In view of the fact that these dielectrically effective layers of aluminum oxide frequently are porous, they are sealed with synthetic resins, and in the case that this sealing is to be effective not only superficially but rather throughout the entire thickness of the layer, this process is carried out in a vacuum, as is known from DE 199 57 644 A1 and WO 01/40544 A1. In practice, however, it turned out that even a pore-deep sealing of the aluminum oxide layer with a synthetic resin can not guarantee that no electrical breakdown to the roller core will occur. The reasons therefore are based on the one hand on the adhesion-promoting layer which usually is provided for in plasma spraying and which has a substantial topography combined with a corresponding peak action (local increase of the field strength up to an electrical breakdown—principle of a lightning conductor), and on the other hand on the dynamics of the roller body during operation including deflections, oscillations and so on, with the consequence that also the aluminum oxide layer sealed with synthetic resin will get fissures or cracks through which the electrical breakdown will take place. An electrical breakdown usually not only means an interruption of the process, but also a destruction of the functionality of the corona roller.

### SUMMARY OF THE INVENTION

The present invention provides for a corona roller having an increased operational safety against electrical breakdowns, and reliable methods for producing such a corona roller.

The object basic to the invention is solved by the claimed methods as well as by the claimed corona roller.

In one aspect of the present invention there is provided a method for producing a corona roller comprising a cylindrical base body and a roller cover of dielectric material where the method comprises the steps of heating a thermoplastic material to a prescribed viscosity and applying an inner layer of the thermoplastic material onto the outer surface of the cylindrical base body. Solid powder particles having electrically insulating characteristics are then imbedded into the material matrix of the heated layer of thermoplastic material in the surface thereof in a form-locking manner such that a portion of the solid powder particles protrudes from the layer. An electrically insulating, wear-resistant outer functional layer is then applied on the particle imbedded layer of the thermoplastic

The functional layer preferably is produced by thermal spraying, wherein the first powder particles are shot into the material matrix of the heated layer of plastic material in the vicinity of the surface thereof in such a manner that they still protrude with a partial region thereof from the layer of plastic material, and wherein in the further course of the spraying operation the protruding powder particles are caused to be bonded with subsequent powder particles forming said functional layer.

According to another aspect of the present method for producing a corona roller, the method comprises the steps of: heating a thermoplastic material to a prescribed viscosity; applying a layer of the thermoplastic material onto the outer surface of the cylindrical base body; dispersing particles of solid material having electrically insulating characteristics into a material matrix of the layer of thermoplastic material in the surface thereof in a form-locking manner such that a portion of the particles of solid material protrude from the layer; and grinding the surface of the layer of the thermoplastic material dispersed with particles of solid material to produce a hard, wear resistant and corrosion resistant surface.

In conformity with a further aspect, the present invention is a corona roller which comprises a cylindrical base body; and a roller cover of dielectric material disposed on the cylindrical base body, wherein the roller cover includes an inner layer of thermoplastic material applied onto the outer surface of the cylindrical base body, wherein the inner layer contains solid powder particles having electrically insulating characteristics imbedded into the material matrix of the inner layer of thermoplastic material proximate the surface thereof in a form-locking manner such that a portion of the solid powder particles protrude from the surface of the inner layer, and wherein the roller cover further includes a hard, wear resistant and corrosion resistant outer functional layer or surface having electrically insulating characteristics.

These and further objects, features and advantages of the present invention will become apparent from the following description when taken in connection with the accompanying drawing which, for purposes of illustration only, shows an embodiment in accordance with the present invention.

### BRIEF DESCRIPTION OF THE DRAWINGS

The single FIGURE shows an example of a corona roller comprising a roller base body and a roller cover which is being used in a corona system.

### DETAILED DESCRIPTION OF THE INVENTION

The cover provided for in conformity with the invention is advantageous particularly in that on the one hand no metallic adhesion-promoting layers are required thereby eliminating the risk of electrical breakdowns via the peak action due to the topography, and that on the other hand even a formation of fissures or cracks in the electrically insulating outer layer will not result in a local total breakdown of the dielectric characteristics and thus an electrical breakdown. The electrical insulation effect of the thermoplastic material, particularly when the specific resistance thereof is at least 10¹²Ω×m, is fully sufficient to secure the functioning of the corona roller, so that the outer layer disposed thereon represents an additional electrical insulation, the main function of the outer layer, however, being protection against wear. A further advantage of the coating in conformity with the invention resides in the fact that the cover of thermoplastic material having a high dielectricity also is highly chemically resistant and safely protects the roller body against corrosion. Subsurface corrosion accompanied by local delamination of the aluminum oxide layer occurs in conventional corona rollers when the surface thereof is treated e.g. with heavily acidic cleaning agents and when the roller body consists of low-alloyed steel.

The layer of plastic material particularly may be covered by an electrically insulating, wear-resistant outer functional layer into which the particle partial regions protruding from the layer of plastic material are imbedded, the outer functional layer preferably consisting of oxide ceramic, particularly Al₂O₃, Cr₂O₃, SiO₂, ZrO₂ or mullite or of a mixture of two or more of these materials.

The material of the layer of plastic material particularly may be thermoplastic polyamides such as the materials known under the trade names RILSAN®, NYLON and PERLON®, i.e. polyamides on the base of castor oil and PA 11 on the base of lactame, polyamides of PA 4, PA 11 (NYLON) or polyamides of PA 6 (PERLON®).

According to a further embodiment of the invention the functional layer has a thickness from 0.05 mm to 3.0 mm, and preferably a thickness of about 0.5 mm. Whereas conventional corona rollers frequently are provided with layers of aluminum oxide which have a thickness of up to 2 millimeters and more and which are correspondingly susceptible to fissures or cracks, the cover according to the subject invention normally permits a reduction of the thickness of the oxide ceramic layer to few tenths of a millimeter. This not only has economical advantages in the production of such coatings for corona rollers, but also offers a substantially increased operational safety because layers of oxide ceramic are much less tending to the formation of cracks under dynamic loads.

A thickness from 0.5 mm to 4 mm and preferably from about 1 mm to 2 mm turned out to be particularly suited for the layer of plastic material, and the surface of the roller cover preferably has a surface roughness of 0.5 μm<Rz<500 μm, particularly a surface roughness Rz from 1.5 μm to 20 μm.

It is to be understood that in both embodiments of the method the outer coating additionally may be provided with a sealing which closes any pores, as known from DE 199 57 644 A1 and WO 01/40544 A1.

The single FIGURE shows an example of a corona roller of the above described type which consists of a roller base body 10 and a roller cover (dielectric) 11 and which is being used in a corona system. The corona system includes an electrode unit 13 provided with an extractor. A foil 12 of plastic material is supported on the corona roller which rotates in the direction of the arrow, whilst the foil passes beneath the electrode unit 13 and is pretreated by electrical discharges such that its surface becomes hydrophilic due to oxidations processes, and thus is made suitable for printing in a conventional offset process.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method for producing a corona roller having a cylindrical base body and a roller cover of dielectric material, the method comprising the steps of:
heating a thermoplastic material to a prescribed viscosity;
applying an inner layer of the thermoplastic material onto the outer surface of the cylindrical base body;
imbedding solid powder particles having electrically insulating characteristics into a material matrix of the heated layer of thermoplastic material in the surface thereof in a form-locking manner such that a portion of the solid powder particles protrudes from said layer; and
applying an electrically insulating, wear-resistant outer functional layer on the particle imbedded layer of the thermoplastic material.

20. The method as claimed in claim 1, wherein the solid powder particles are shot into the material matrix of the heated layer of thermoplastic material in the surface thereof.

21. The method of claim 1 wherein the step of applying the outer functional layer further comprises thermal spraying powder particles to form the outer functional layer on the particle imbedded layer of the thermoplastic material, and wherein the protruding powder particles of the inner layer bond with thermal sprayed powder particles of the outer functional layer.

22. The method of claim 3 wherein the outer functional layer has a thickness from 0.05 mm to 3.0 mm.

23. A method for producing a corona roller having a cylindrical base body and a roller cover of dielectric material, the method comprising the steps of:
heating a thermoplastic material to a prescribed viscosity;
applying a layer of the thermoplastic material onto the outer surface of the cylindrical base body;
dispersing particles of solid material having electrically insulating characteristics into a material matrix of the layer of thermoplastic material in the surface thereof in a form-locking manner such that a portion of the particles of solid material protrude from the layer; and
grinding the surface of the layer of the thermoplastic material dispersed with particles of solid material to produce a hard, wear resistant and corrosion resistant surface.

24. The method of claim 5, wherein the particles of solid material are dispersed into the material matrix of the thus heated layer of thermoplastic material by means of a blasting system.

25. The method of claim 5, wherein said layer of thermoplastic material is applied onto the cylindrical base body of the roller using a fluidized bed process or a thermal spray process.

26. The method of claim 5, wherein said layer of thermoplastic material is applied at a thickness from 0.5 mm to 4 mm.

27. The method of claim 5, wherein the surface of the roller cover is ground or polished to a surface roughness of 0.5 μm<Rz<500 μm.

28. A corona roller comprising:
a cylindrical base body; and
a roller cover of dielectric material disposed on the cylindrical base body,
wherein the roller cover includes an inner layer of thermoplastic material applied onto the outer surface of the cylindrical base body,
wherein the inner layer contains solid powder particles having electrically insulating characteristics imbedded into the material matrix of the inner layer of thermoplastic material proximate the surface thereof in a form-locking manner such that a portion of the solid powder particles protrude from the surface of the inner layer,
wherein the roller cover further includes a hard, wear resistant and corrosion resistant outer functional layer or surface having electrically insulating characteristics.

29. The corona roller of claim 10 characterized in that the outer functional layer comprises a ceramic oxide selected from the group consisting of Al2O3, Cr2O3, SiO2, ZrO2 or mullite or of a mixture of two or more of said materials.

30. The corona roller of claim 10 characterized in that the thermoplastic material is a polyamide having has a specific resistance of at least 1012Ω×m.

31. The corona roller of claim 10 characterized in that the solid powder particles imbedded into the material matrix of the layer of thermoplastic material consist of the same material as the functional outer layer.

32. The corona roller of claim 10 characterized in that the inner layer of thermoplastic material has a thickness from about 0.5 mm to 4 mm and the outer functional layer has a thickness from about 0.05 mm to 3.0 mm.

33. The corona roller of claim 10 characterized in that a surface of the roller cover has a surface roughness of between about 0.5 μm<Rz<500 nm.
